(19) United States
(12) Patent Application Publication
(10) Pub. No.: US 2009/0145530 A1
(43) Pub. Date: Jun. 11, 2009

(54) Wheel Traction Cover with Traction Pads

(76) Inventor: Kurt Lammon, Rainsville, AL (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 12/242,098

(22) Filed: Sep. 30, 2008

Related U.S. Application Data
(60) Provisional application No. 60/976,664, filed on Oct. 1, 2007.

(51) Int. Cl. B60C 27/20

(52) U.S. Cl. 152/226

(57) ABSTRACT

A wheel traction cover includes an interior skirt, an exterior skirt and outer circumferential belt extending between the skirts having a plurality of traction pads extending outward from the belt.

The present application claims priority to the Oct. 1, 2007 filing date of provisional patent application, U.S. Ser. No. 60/976,664 which is incorporated herein by reference.

### FIELD OF THE INVENTION

This invention relates to a removable traction device for vehicle tires, the device having traction pads for improving traction between the tires and slippery or wet surfaces.

### BACKGROUND OF THE INVENTION

Certain tires are usually not suitable for use in snowy road situations and it has been the practice to put chains on tires for use on snow covered surfaces. The fitting of chains is cumbersome and time consuming. An alternative is to provide specially designed snow tires which can be fitted to a vehicle for use during adverse weather conditions, but these tires need to be removed and replaced with normal tires, at least on a seasonal basis.

Other types of traction devices are also known, such as in U.S. Pat. No. 3,335,776 which describes an expandable traction device comprising a band of flexible material fitted around the tire and bonded to the tire by means of a pressure adhesive. Also a variety of plastic or fabric “sock” like covering for tires have been designed such as disclosed in U.S. Pat. No. 5,624,509 and 7,013,548. Various techniques have also attempted to attach traction devices around wheels including U.S. Pat. No. 6,308,757.

Many issues must be addressed when adding traction devices to vehicle tires, particularly, truck and automobile tires which may be driven at speeds between 30-60 miles an hour, even in adverse weather conditions. When driven at speeds approaching at least 30 miles an hour, traction products may cause undesirable sound and harsh vibration. In addition, some devices may track badly and become misaligned on vehicle tires after relatively short distances. Other products have very limited durability and provide only a short useful life. Durability issues are aggravated by harsh conditions including abrasion, friction and heat, and simply the stress of being used on a vehicle weighing between about one and three tons, or even more for commercial vehicles.

While fabric coverings or “socks” for vehicle tires have achieved some of the desired benefits, previous sock-like products have failed to offer sufficiently increased traction, particularly on icy surfaces. Accordingly, a need exists for an improved traction enhancing device for vehicle tires that can be easily installed, provides good performance and durability characteristics, and provides greater traction enhancing benefits that have heretofore been available.

### SUMMARY OF THE INVENTION

To address these and other concerns, a device has been designed comprised of a fabric tire covering with an outer circumference or belt to which traction pads are attached. Traction pads may be advantageously made of flexible urethane plastic or rubber. The flexible traction pads provide for greater durability and traction than wheel sock devices made exclusively of fabric. Metal ice studs or similar devices to increase traction on ice may also be incorporated into the traction pads. The belt portion of the device can be made of fabric with traction pads bonded, stitched or otherwise attached to it, or the belt may be comprised entirely of urethane or rubber with traction pads attached or molded into the belt. The circumferential belt is advantageously provided with an inner side skirt and an outer side skirt, both of which are made of a durable fabric or fabric like material. The outer side skirt may cover the outer face of the vehicle tire completely or may leave the center of the wheel and tire assembly uncovered. The primary purpose of the inner and outer skirts is to support the outer circumferential belt and to hold it in the proper position so that the traction pads remain positioned around the circumference of the tire. The entire wheel covering itself may be split radially on its circumference for ease of installation, or it may be circumferentially continuous and installed over the tire in a sock like fashion.

In one embodiment of the invention the traction pads have traction enhancing displacement chambers as described in U.S. Pat. No. 6,308,757, however, other traction patterns such as chevrons or traction ridges may be suitably used in alternative embodiments. In a further enhancement of the device, metal spikes or snow studs formed of any ice traction enhancing hardened material may be incorporated into the flexible traction pads on the outer circumference of the device.

### BRIEF DESCRIPTION OF THE DRAWINGS

The present invention will be understood from the detailed description below taken in reference with the accompanying drawings that are provided by way of illustration only and thus are not limiting of the present invention and wherein:

FIG. 1A is an exterior side plan view of an embodiment of a wheel cover according to the invention.

FIG. 1B is an end view of the wheel cover of FIG. 1A.

FIG. 1C is an interior side plan view of the wheel cover of FIG. 1A.

FIG. 2 is a sectional view of an embodiment of a wheel cover according to the invention in place over a vehicle tire.

FIG. 3A is an exterior side plan view of a second embodiment of a wheel cover according to the present invention.

FIG. 3B is an end plan view of the wheel cover of FIG. 3A.

FIG. 4 is a perspective view of an exemplary traction pad that may be used with wheel covers of the present invention.

FIG. 5A is an exterior side plan view of a third embodiment of a wheel cover according to the invention.

FIG. 5B is an end view of the wheel cover of FIG. 5A.

FIG. 6 is an exterior side plan view of a fourth embodiment of a wheel cover according to the invention.

FIG. 7 is a top plan view of a second exemplary traction pad that may be used with wheel covers of the present invention.

FIG. 8 is a sectional view of the traction pad of FIG. 7 taken along line A-A.

FIG. 9 is a sectional view of the traction pad of FIG. 7 taken along the line B-B.

FIG. 10A is a top plan view of a third exemplary traction pad that may be used with wheel covers of the present invention.

FIG. 10B is a side sectional view of the traction pad of FIG. 10A shown in position on a tire.

### DETAILED DESCRIPTION OF THE DRAWINGS

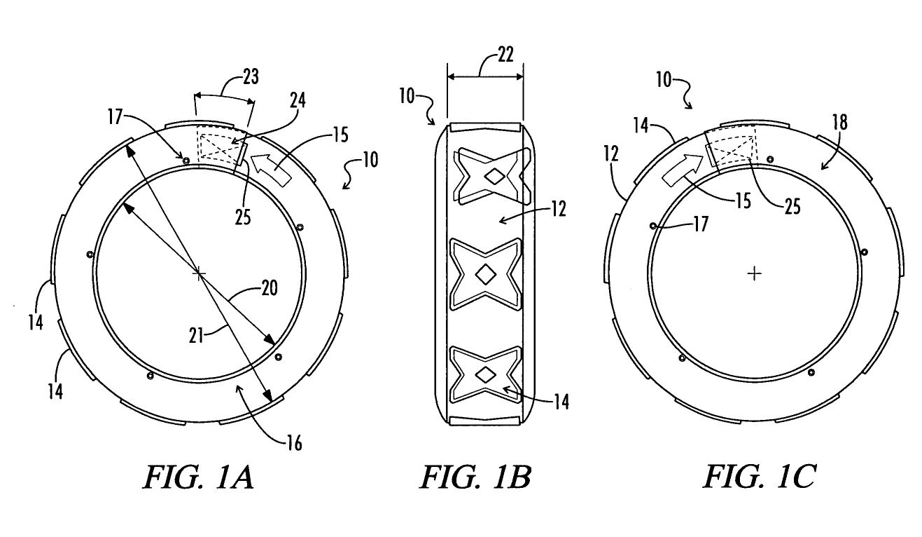

Turning then to FIG. 1A, a wheel cover 10 is illustrated with outer skirt 16 having an inner diameter 20 and an outer diameter 21, a plurality of eyelets 17, a directional arrow 15 and hook fasteners 24 on inner surface and loop fasteners 25 on outer surface and overlapping portion 23 allowing the hook and loop pads 24, 25 to grip one another. In FIG. 1B traction pads 14 are shown mounted in place on outer circumferential belt 12 which has a width 22. Outer circumferential belt 12 extends between the outer skirt 16 in FIG. 1A and the inner skirt 18 in FIG. 1C.

The skirts 16, 18 may be manufactured from a variety of material such as 600 denier polyester or nylon fabric, neoprene or PVC coated tarp material, or other substantial woven, nonwoven and impregnated fabrics. The belt 12 may similarly be made of a variety of materials including urethane or rubber, but more preferably thick rubber coated cloth or other impregnated woven or nonwoven fabrics, 1000 denier nylon fabric or other substantial fabric-like material. The illustrated cover 10 is split radially with overlapping segment 23 so that hook fastener pad 24 at leading edge can be placed on the tire and then covered by trailing edge with hook fastener pad 25 so that hook and loop fasteners on respective pads 24, 25 secure the cover 10 on the tire. Further, securing means such as elastic straps may be affixed to eyelets 17 to pull the cover 10 against the vehicle tire. The difference in the inner diameter 20 and outer diameter 21 of the skirts 16, 18 is typically on the order of 6 to 12 inches. Thus, an exemplary size for a wheel cover according to the invention designed for use on a 265/70-16 passenger car tire might be inner diameter of 22 inches, an outer diameter of 31 inches and a width of a 8.5 inches. The overlapping section 23 is typically on the order of 3-12 inches in length depending on the exact fastening configuration.

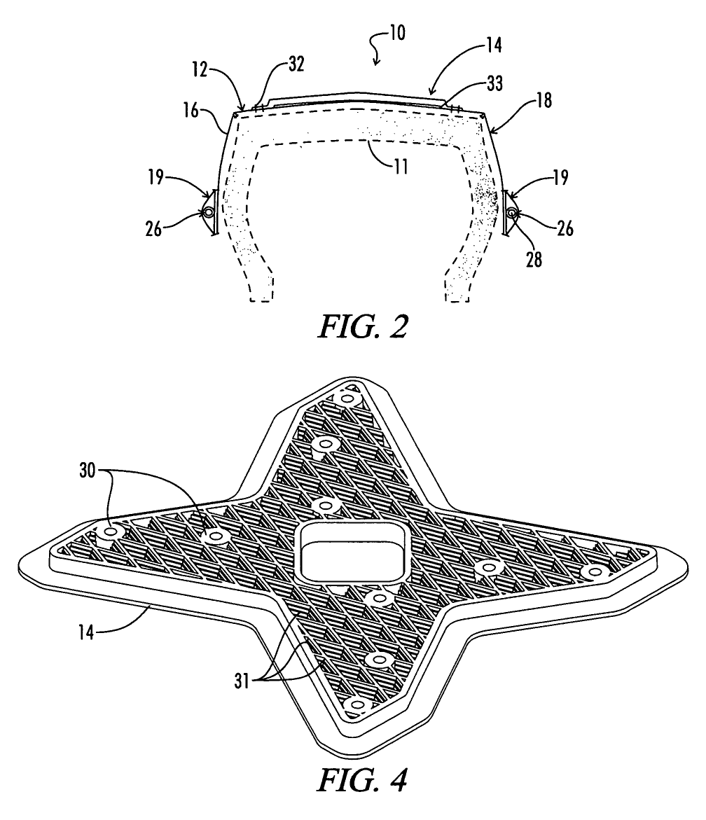

FIG. 2 illustrates an alternative embodiment of a wheel cover 10 having inner skirt 18, outer skirt 16 and circumferential belt 12. Traction pads 14 are attached to circumferential belt 12 by stitching 32 and adhesive 33. At the interior inner edges of skirts 16, 18 are formed pockets 19 which may advantageously include elastic bands or illustrated cable sheaths 26 and cables 28. Cable sheaths 26 are typically plastic tubing such as 0.25 to 0.375 inch outer diameter polyethylene tubes. Cables 28 are preferably braided wire cables or rope.

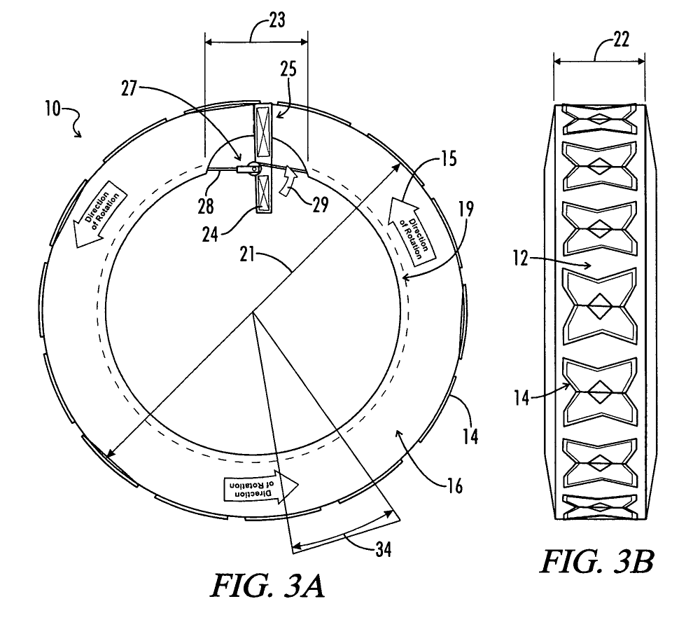

FIG. 3A illustrates a side view of an embodiment of a wheel cover 10 with cables 28 and inner skirt pockets 19. The cover 10 has outer skirt 16, traction pads 14, directional indicators 15, outer diameter 21 and overlapping segment 23. Here it is seen that cable 28 is fixed at one end to a cable fastening device 27 and the other end of the cable 28 is fed around the inner skirt pocket 19 and back to the fastening device 27 and tightened appropriately. The cable fastening device 27 may be a ratchet mechanism, a cable turnbuckle, flexible straps with D-rings, or other adjustable fastening device. FIG. 3A also shows that the spacing between traction pad 14 centers may advantageously be approximately 25 degrees permitting mounting of fourteen pads on a car sized tire. Generally, it has been determined too few traction pads 14 leads to a rough noisy ride, while between about 9 to 25 pads having an angular spacing of between 14° and 40° between centers, produces a more comfortable ride experience. On a car tire, traction pads 14 will typically be about 6″ wide and 4″ to 5″ in length. The spacing between pads should not exceed about 2.5″ and the spacing should permit one pad to always be in contact with the road surface. Pads 14 preferably have a durometer of between about 60-80 Shore A hardness.

FIG. 4 illustrates a representative traction pad 14 having metal studs 30 to improve ice traction and displacement chambers 31 according to U.S. Pat. No. 6,308,757 to improve traction in various adverse conditions. It is to be appreciated that traction pads may be made of a wide variety of materials, preferably urethane or rubber, may or may not include ice studs and may advantageously be utilized in many other configurations than that of FIG. 4 including simple chevron tread designs. Preferably, the traction pads 14 with displacement chambers have a relatively soft durometer, between about 60-65 durometer, although substantial variations durometer may be appropriate for different applications. In the exemplary embodiment, metal studs have a base about 0.6 inches in diameter and a plurality of small feet having an area of about 0.01 square inches to mate securely with a base urethane layer having a thickness of about 0.02 to 0.04 inches, and an upstanding metal spike about 0.15 to 0.2 inches in diameter and extending upwards from the base approximately 0.4 inches to protrude through an upper urethane layer and provide traction on ice or other slippery surface.

Fastening traction pads 14 to belt 12 presents structural issues due to stresses placed upon pads 14, as well as the heat, friction and abrasion that wheel covers 10 are subjected to when driven at reasonable speeds. Accordingly, it is desirable to utilize rubber traction pads that have been abraded on their mounting surface with a cushion adhesive to affix those pads to a cured rubber coated cloth belt 12. This bonding of the pads may be further enhanced by stitching with heavy duty thread on the flanges or in the recessed portions of the pads 14.

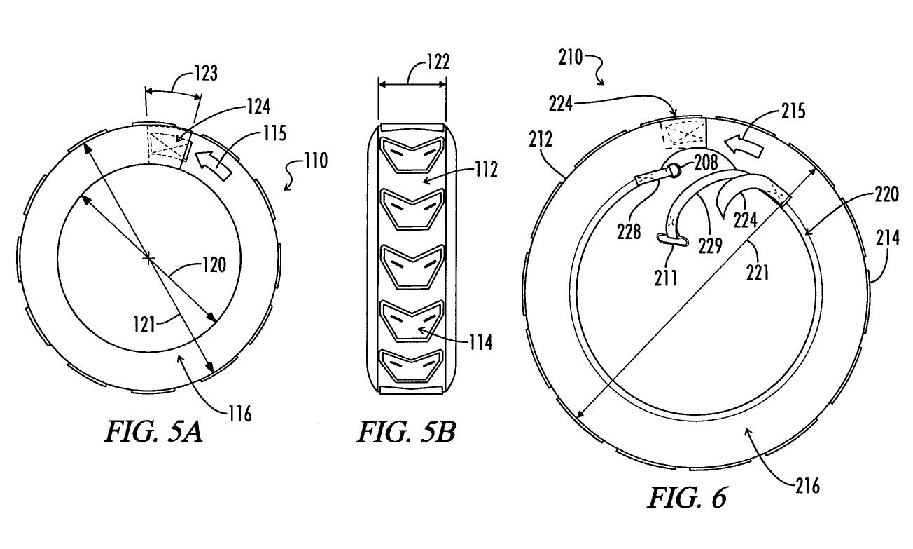

FIG. 5A illustrates wheel cover 110, with outer skirt 116 having an inner diameter 120 and an outer diameter 121, a directional arrow 115, hook fasteners 124 on inner surface, loop fasteners 125 on outer surface and over lapping portion 123 allowing the hook and loop pads 124, 125 to grip one another. In FIG. 5B, traction pads 114 are shown mounted in place on outer circumferential belt 112 which has a width 122.

FIG. 6 illustrates another wheel cover 210, with outer skirt 216 having an inner diameter 220, an outer diameter 221, a directional arrow 215 and flexible belts 228, 229 with D-rings 208, 211, to secure the inner diameter of the skirt 216. Another flexible belt 224 may be provided with hook and loop fasteners to hold the flexible belts 228, 229 in position. The outer circumferential belt 212 has traction pads 214 mounted thereon.

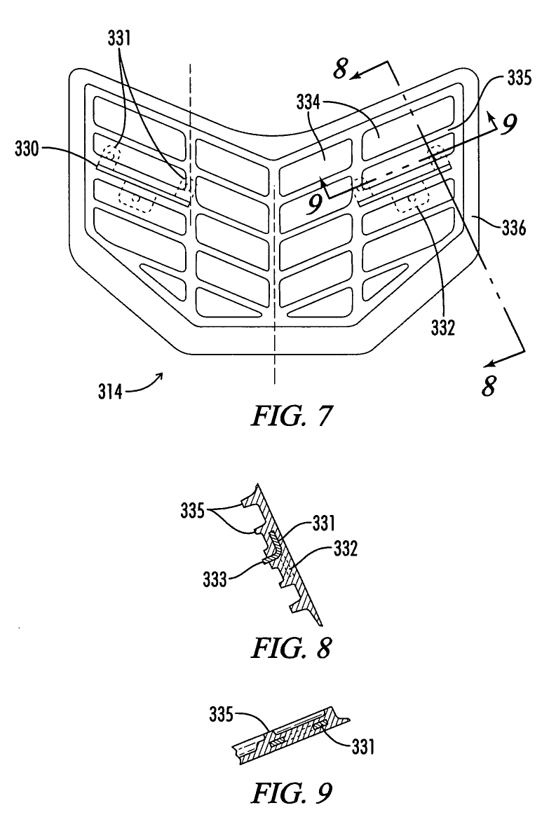

FIG. 7 illustrates an alternative traction pad 314 which is shown in partial sectional views in FIG. 8 and FIG. 9. Traction pad 314 is approximately 5-6 inches wide and 4 inches in length with a raised grid 335 separating depressions 334 in the pad 314. Again, the pad can be braided upon its bottom mounting surface and is secured with a cushion adhesive to a cured rubber coated cloth belt. Of particular note are studs 330 with stabilizing members such as rear support 331 and front support 332 to hold stud 330 in place with protruding edge 333 grasping the surface on which the tire is traveling. A single stud 330 on each side of the traction pad 314 is preferred, although multiple studs and varied configurations are possible. The height from the stabilizing feet 331, 332 to the top of the protruding edge 333 is approximately one-third of an inch. The depth of the depressions 334 in the traction pad 314 is approximately one-sixth of an inch. Traction pads 14 also have a flange of between about one-eighth and one-fifteenth of an inch, and the flange allows the traction pads 314 to be easily stitched to the outer circumferential belt.

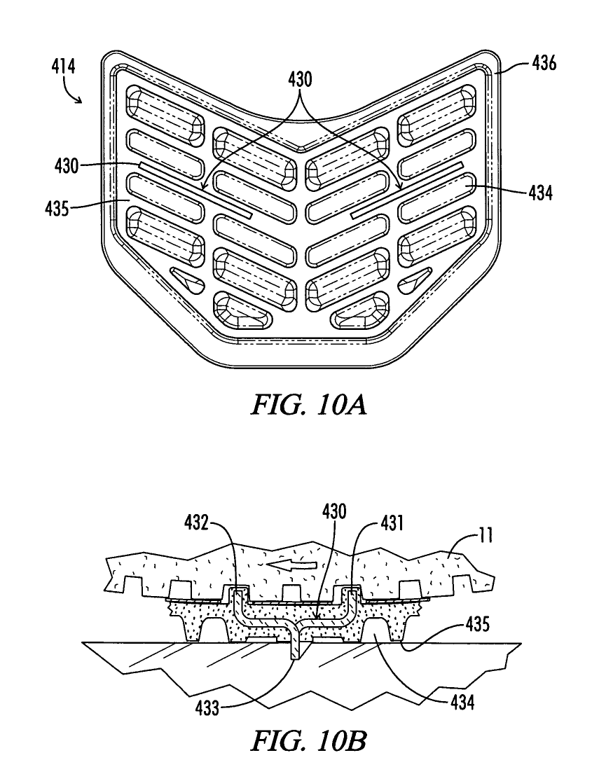

The details of an alternative preferred traction pad 414 are illustrated in FIGS. 10A and 10B. This traction pad 414 has the same outer flange 436, depressions 334, and raised grid 435, as prior traction pads. However, a rigid and preferably metal cleat 430 has as stabilizing members a forward positioning foot 432 and a rear positioning foot 431 that may be received in the tread of the tire upon which the traction device 10 is secured. In this fashion, when the tire 11 rotates, the positioning feet 432, 431 hold the cleat 430 in position relative to the tire and the protruding edge 433 is able to grip the ice or other material that the tire is contacting securely and the outer circumferential belt 12 of traction device 10 is not permitted to slip with respect to the tire 11.

Although the only illustrated embodiments of the wheel cover 10 are shown split radially for ease of fastening about the vehicle tire, it is also possible to manufacture wheel covers in a continuous fashion without hook and loop or other fastening devices. In such cases, it is desirable to place an elastic band or other tensioning device in the wheel cover 10, such as in inner skirt pocket 19 illustrated in FIG. 2.

All publications, patent, and patent documents mentioned herein are incorporated by reference herein as though individually incorporated by reference. Although preferred embodiments of the present invention have been disclosed in detail herein, it will be understood that various substitutions and modifications may be made to the disclosed embodiment described herein without departing from the scope and spirit of the present invention as recited in the appended claims.

I claim:

1. A wheel traction cover comprising:
an interior skirt;
an exterior skirt;
an outer circumferential belt extending between interior skirt and exterior skirt; and
a plurality of traction pads mounted to and extending outward from the outer circumferential belt.

2. The wheel traction cover of claim 1 wherein the traction pads have a diameter of between 60-80 Shore A hardness.

3. The wheel traction cover of claim 1 wherein the traction pads further comprise a metal stud.

4. The wheel traction cover of claim 3 wherein the metal stud further comprises forward and rear stabilizing members.

5. The wheel traction cover of claim 4 wherein the wheel traction cover is mounted around a vehicle tire having a tread design and the stabilizing members are received within recesses in the tread design.

6. The wheel traction cover of claim 1 wherein the outer circumferential belt is circumferentially continuous.

7. The wheel traction cover of claim 1 wherein the outer circumferential belt is split radially.

8. The wheel traction cover of claim 1 wherein between 9 and 25 traction pads are mounted to the outer circumferential belt.

9. The wheel traction cover of claim 1 wherein the outer circumferential belt is fabricated from at least one of the group of rubber coated cloth, rubber or urethane impregnated woven fabric, rubber or urethane impregnated nonwoven fabric, and 1000 denier nylon fabric.

10. The wheel traction cover of claim 1 wherein at least one of the interior skirt and the exterior skirt has an interior edge with a pocket.

11. The wheel traction cover of claim 10 wherein the pocket holds a cable or an elastic band to secure the skirt about a vehicle tire.

12. The wheel traction cover of claim 1 wherein at least one of the interior skirt or exterior skirt has an interior edge with eyelets to receive securing means.

13. The wheel traction cover of claim 7 wherein a leading edge of the cover has an outward facing fastener material and can be placed on a vehicle tire and covered by a trailing edge of the wheel traction cover having an inward facing fastener material that cooperates with the outer facing fastener material to secure the wheel traction cover about the vehicle tire.

14. The wheel traction of claim 1 wherein the traction pads are integrally molded in the outer circumferential belt.

15. The wheel traction cover of claim 1 wherein the traction pads are attached to the circumferential belt by stitching and adhesives.

16. The wheel traction cover of claim 1 wherein the spacing between traction pads does not exceed 2.5 inches.

17. The wheel traction cover of claim 1 wherein the traction pads further comprise displacement chambers.

18. A wheel traction cover comprising:
an interior skirt;
an exterior skirt;
an outer circumferential belt extending between interior skirt and exterior skirt, all of the interior skirt, exterior skirt and outer circumferential belt being split radially; and
a plurality of traction pads mounted to and extending outward from the outer circumferential belt wherein at least one of the interior skirt and the exterior skirt has an interior edge with a pocket and the pocket holds a cable or an elastic band to secure the skirt about a vehicle tire.

19. The wheel traction cover of claim 18 wherein the traction pads are angularly displaced from one another by between 18 and 30 degrees and the spacing between the traction pads does not exceed 2.5 inches.

20. The wheel traction cover of claim 18 wherein the traction pads further comprise a metal stud with forward and rear stabilizing members so that when the wheel traction cover is mounted around a vehicle tire having a tread design, the forward and rear stabilizing members are received within recesses in the tread design.
